(19) United States
(12) Patent Application Publication
(10) Pub. No.: US 2005/0021938 A1
(43) Pub. Date: Jan. 27, 2005

(54) Document access control system and method

(75) Inventor: Kazuaki Kidokoro, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/457,469

(22) Filed: Jun. 10, 2003

(51) Int. Cl. H04L 9/00

(52) U.S. Cl. 713/152

(57) ABSTRACT

A system and method for controlling transmission of an e-mail message includes determining whether an e-mail message being transmitted to one or more addresses includes a link to a document, detecting each of the one or more addresses to which the e-mail message is being transmitted, and creating a common user account for the detected one or more addresses. An access right to the linked document is for each of the one or more addresses in the common user account, and the e-mail message is transmitted with the document link to each of the one or more addresses.

### FIELD OF THE INVENTION

The present invention relates generally to document access control and, more particularly, to a system and method for controlling access to documents shared through the use of e-mail messages.

### BACKGROUND OF THE INVENTION

The increasing connectivity of computer users through local and public networks such as LANs, WANs and the Internet, has created a corresponding increase in the ability to share information among users regardless of location. For example, if the sharable information is stored at a commonly accessible location, a user can provide access to the sharable information to another user by providing a link to the location in an e-mail sent to the other user. Sharing a document by providing the necessary link to it, such as a URL, is an efficient way to share the document because it uses far less memory then sending a copy of the original document to all of the recipients of the e-mail. One problem, however, with sending a link is that it may make the document accessible to anyone capable of receiving the e-mail. This problem complicates the document owner's responsibility to control access to the document.

Because of this problem, the document owner may elect to send the document itself instead of the link to the document. Sending the document instead of the link raises access control problems as well. The document sent is a copy of the original document. As a result, the sent document is out of the control of the document owner, and any subsequent changes to the original document will not be reflected in the copy sent.

One access control system that is used to improve access control to information is to use an encryption system. Using such a system, original information can be encrypted in a multitude of ways. For example, Microsoft Word (a product of Microsoft Corporation) enables the original information to be encrypted with a password. Whatever the encryption system, the process of encrypting requires additional steps for users who want to share information, and may require special knowledge of the technology.

It would therefore be useful to provide an easy way to handle access rights to shared information.

### SUMMARY OF THE INVENTION

Briefly, in one aspect of the invention, a system and method for controlling transmission of an e-mail message includes determining whether an e-mail message being transmitted to one or more addresses includes a link to a document, detecting each of the one or more addresses to which the e-mail message is being transmitted, and creating a common user account for the detected one or more addresses. An access right to the linked document is for each of the one or more addresses in the common user account, and the e-mail message is transmitted with the document link to each of the one or more addresses.

### BRIEF DESCRIPTION OF THE DRAWINGS

FIG. 1 is a block diagram of a document access system according to an embodiment of the present invention.

FIGS. 2A and 2B are flow diagrams of a process for providing access to a shared document according to an embodiment of the present invention.

FIGS. 3A and 3B are flow diagrams of another process for providing access to a shared document according to an embodiment of the present invention.

FIGS. 4A and 4B are flow diagrams of another process for providing access to a shared document according to an embodiment of the present invention.

FIGS. 5A and 5B are flow diagrams of another process for providing access to a shared document according to an embodiment of the present invention.

### DETAILED DESCRIPTION OF THE PREFERRED EMBODIMENT

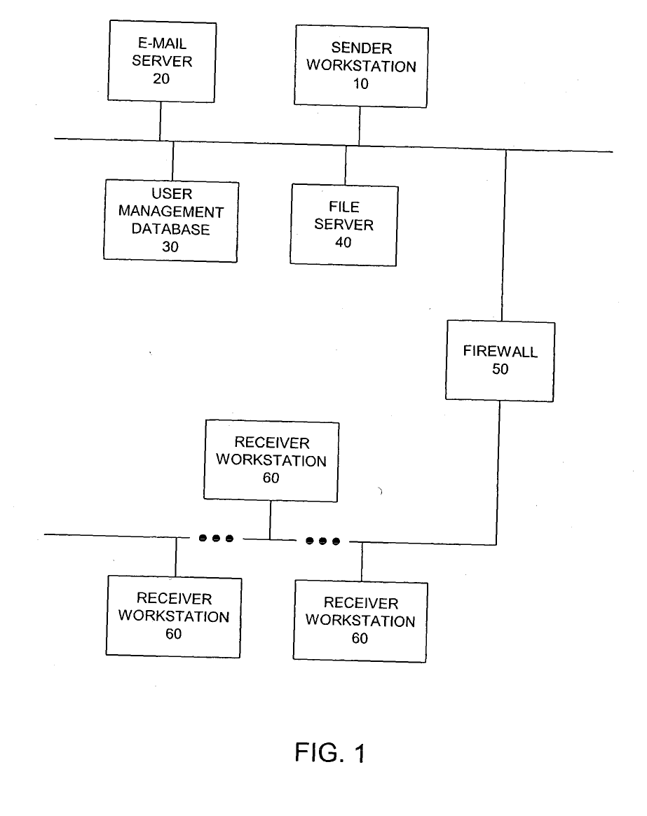

FIG. 1 is a block diagram of a document access system according to an embodiment of the present invention. As shown in FIG. 1, the document access system includes a sender workstation 10, an e-mail server 20, a user management database 30, a file server 40, a firewall 50 and a plurality of receiver workstations 60. Each of these components may be coupled together by a network connection or by a direct communication connection. The network connection may be implemented by a local network, such as a LAN, or a public network, such as the Internet.

The sender workstation 10 and receiver workstations 60 may be a PC, a mobile phone, a PDA, a magnetic card, or some combination thereof, or any other computing structure. Each preferably includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the sender workstation 10 and receiver workstations 60 provides a two-way data communication coupling, such as to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information.

If the network connection is an Internet connection, the sender workstation 10 and receiver workstations 60 can transmit a requested code for an application program through the Internet, an ISP, the local network and the communication interface. The received code can be executed by the CPU in the sender workstation 10 and receiver workstations 60 as it is received, stored in the storage device, or stored in some other non-volatile storage for later execution. In this manner, the sender workstation 10 and receiver workstations 60 may obtain application code in the form of a carrier wave.

Like the sender workstation 10 and receiver workstations 60, the e-mail server 20 and file server 40 preferably include a CPU, a main memory, a ROM, a storage device and a communication interface all coupled together via a bus. The e-mail server 20 is configured to enable the sender workstation 10 and receiver workstations 60 to create e-mail messages. The e-mail server 20 is also configured to handle the sending and receiving of e-mail messages, as well as storing e-mail messages.

The file server 40 stores a plurality of documents in a non-volatile storage area, such as a hard disk drive or NVRAM. For the purposes of this application, a document can be considered any kind of information (including in any format) that can be accessed and/or shared by the sender workstation 10 and the receiver workstations 60. The user management database 30 includes information about users of documents stored in the file server 40. In addition to information identifying the users, the user management database 30 also includes information about the access rights the users have to respective documents stored in the file server 40. The information included in the user management database 30 may be stored in a non-volatile storage area, such as a hard disk drive or NVRAM.

As shown in FIG. 1, the sender workstation 10, e-mail server 20, user management database 30 and file server 40 can all be part of the same local network. As part of the same local network, the firewall 50 provides protection to these devices in the local network from unwanted access. It is also possible for each of these devices to be independent of a local network, with access provided by access through the Internet.

The sender workstation 10 is capable of composing an e-mail message with the e-mail server 20, attaching to the e-mail message a document or a link to a document stored in the file server 40, and set access rights in the user management database 30 to the document. In addition, the user can encrypt the document. The document or link can be sent to one or more receiver workstations 60 by including the address of each receiver workstation 60 in the e-mail message.

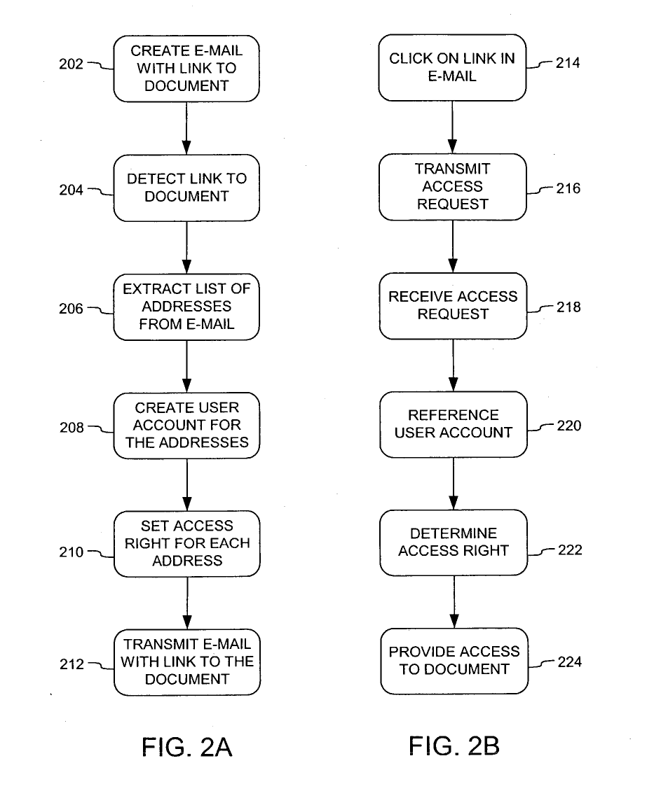

FIGS. 2A and 2B are flow diagrams of a process for providing access to a shared document according to an embodiment of the present invention. As shown in FIG. 2A, a user first creates an e-mail message with a link to the document (step 202). For example, a user at the sender workstation 10 can create the e-mail message using the e-mail server 20 with a link to a document stored in the file server 40. The link can be a local address corresponding to the location where the document is stored in the storage area of the file server 40 or a universal address, such as a URL or HTTP address. The user also identifies each of the addresses to which to send the e-mail message. The addresses can be e-mail addresses of the sender workstations 60.

Before the e-mail is transmitted to the addresses identified in the e-mail message, the system detects whether there is a link to a document in the e-mail message (step 204). This detection can be performed by the e-mail server 20 or whatever e-mail application the user used to create the e-mail message. In addition to being configured to create, send, receive and store e-mail messages, the e-mail server 20 can be configured to analyze an e-mail message prior to being transmitted to determine whether the e-mail message includes a document or a link to a document.

If a link to a document is detected, each of the addresses identified in the e-mail message are extracted (step 206). The extraction of the addresses can also be performed by the e-mail server 20 or e-mail application used to create the e-mail message. The extracted addresses are then used to create a user account (step 208). The user account includes information identifying one or more users, such as by their addresses. The user account also includes information identifying what rights each user has to access a document, i.e., an access control list to the document. The document being accessed can be a document stored in the file server 40. The user account can be stored in the user management database 30. The user account can be a single account storing information for each of the users addressed in the e-mail message. This single account can be associated with a particular document and store information identifying access control information to the document for one or more users.

Alternatively, the user account can be a plurality of accounts, where each of the plurality of accounts stores information for a respective one of the users addressed in the e-mail message. Each of the plurality of accounts can then store access control information for more than one document for a respective user. In other words, each user can have a respective user account, which stores access control information for that user to each of one or more documents.

An access right to the linked document is set for each address extracted from the e-mail message (step 210). The access right defines the manner in which the recipient of the linked document may view and/or modify the document. Examples of access rights can be, for example, read-only and read/write access. The access right can be set automatically to default to a particular access right, such as read-only. Alternatively, the user sending the link to the document can be prompted to enter what access right to set. When prompted, the user can set the same access right for all of the addresses or set access rights individually for each address. The access rights are stored in the user account created for the addresses extracted from the e-mail message. The e-mail server 20 or e-mail application used to create the e-mail message can be configured to create the user account and set the access rights for the addresses extracted from the e-mail message.

Having created the user account and set the access rights, the e-mail message with the link to the document is sent to all of the addresses in the message (step 212). The e-mail server 20 or e-mail application used to create the e-mail message can be configured to control the transmission of the e-mail message, such as from the sender workstation 10 to one or more of the receiver workstations 60. The message can be considered transmitted once it leaves the e-mail sender workstation.

The recipients of the e-mail message can use the provided link to access the document. As shown in FIG. 2B, the user can access the document by first clicking on the link in the e-mail message (step 214). The user can click on the link using a pointing device, such as a mouse, and depressing a key on the pointing device when the pointer icon is over the link.

In response to clicking on the link to the document in the e-mail message, an access request is transmitted to the location of the document (step 216). The access request includes information identifying the location of the document, such as by its HTTP address, and information identifying the user sending the access request, such as the user's e-mail address. The information identifying the location of the document can be used to direct the transmission of the access request. The access request is received at the location of the document (step 218). For example, if the e-mail message links to a document residing in the file server 20, then the access request is transmitted to the file server 20.

Before access to the document is enabled, the user account corresponding to the document is referenced (step 220). As described above, the user account may be stored in the user management database 30, which is associated with the file server 20 where the linked document is stored. The user account is referenced to determine whether or not the user that transmitted the access request has rights to access the document. For example, the user that transmitted the access request is entitled to access the document if the information identifying the user, such as the user's e-mail address, is denoted in the user account. If the information identifying the user is not denoted in the user account, then the user is not entitled to access the document. This may occur if the original recipient of the e-mail forwards the link to the document to another address that was not among the original addresses included in the e-mail message.

If the user transmitting the access request is entitled to access the document, the next step is to determine what access right the user has to the document (step 222). As described above, the user account associated with the document identifies the access right for each recipient address. Using the address identifying the user transmitting the access request and the user account information, the system can determine what access right the user has to the linked document.

Based on the determined access right, the user is provided access to the document (step 224). For example, if the determined access right is read-only, then the user is only able to view the document, but not change its contents. However, if the determined access right is read-write access, then the user is allowed to view the document, as well as change its contents. The system may store the fact that a change has been made by a particular user.

As described above with respect to FIGS. 2A and 2B, a user can send a link to a document to one or more addresses and limit the access to the document to those addresses, as well as control the type of access to the document. When sending an e-mail message with a link to a document, it is possible that the document is encrypted. If the document is encrypted, the user receiving the link to the document may be unable to access the document.

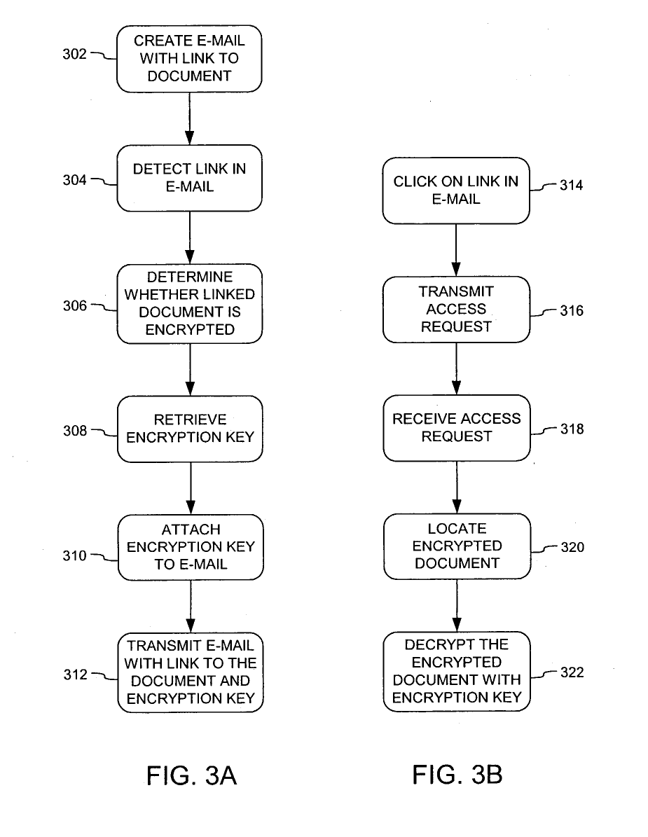

FIGS. 3A and 3B are flow diagrams of another process for providing access to a shared document according to an embodiment of the present invention. As will be described below, this process enables users receiving a link to an encrypted document to access and view the encrypted document. As shown in FIG. 3A, a user first creates an e-mail message with a link to the document (step 302). As described above with respect to FIG. 2A, a user at the sender workstation 10 can create the e-mail message using the e-mail server 20 with a link to a document stored in the file server 40 and a list of the addresses to which to send the e-mail message.

Before the e-mail is transmitted to the addresses identified in the e-mail message, the system detects whether the e-mail message contains a link to a document (step 304). If a link is detected, the system determines whether the linked document is encrypted (step 306). The e-mail server 20 or e-mail application used to create the e-mail can be configured to locate the document and determine whether or not it is encrypted. The document may be encrypted using available encryption algorithms as are known in the art. The present process contemplates the use of any such available encryption algorithm.

If the document is encrypted, the encryption key for decrypting the document is retrieved (step 308). The encryption key depends on the type of encryption algorithm used to encrypt the document, and it may, for example, a password or a binary key file (used for PDP algorithms). The e-mail server 20 or e-mail application used to generate the e-mail message can be configured to access the file server 20 or other local files of the sender workstation 10 to identify the location of the encryption key so it can be retrieved. In addition to retrieving the encryption key, it is possible to further encode the key with information about the recipient addresses of the e-mail message. The encoding of this address information can limit the use of the encryption key to users associated with those addresses. The encoding of the encryption key can also include information identifying the access right for those addresses. The access right can be a default setting, or the user can be prompted to identify the access right individually for each recipient. Instead of encoding the encryption key, it is also possible to extract the addresses, create the user account and set the access right for each of the addresses as described above with respect to FIG. 2A.

The retrieved encryption key is attached to the e-mail message along with the link to the encrypted document (step 310). The e-mail message with the link to the document and the encryption key is then sent to each of the addresses in the message (step 312). The e-mail server 20 or e-mail application used to create the e-mail message can be configured to control the transmission of the e-mail message, such as from the sender workstation 10 to one or more of the receiver workstations 60.

A user at one of the designated addresses can access the encrypted document by clicking on the link in the e-mail message, such as using a mouse (step 314). In response to clicking on the link to the document in the e-mail message, an access request is transmitted to the location of the document (step 316). The access request includes information identifying the location of the document, such as by its HTTP address, information identifying the user sending the access request, such as the user's e-mail address, and the encryption key. The information identifying the location of the document can be used to direct the transmission of the access request. The access request is received at the location of the document (step 318).

The encrypted document is then located (step 320). The location of the document can be determined form the information in the access request. The document is then decrypted using the encryption key included in the access request (step 322). The manner in which the document is decrypted depends on the algorithm used to encrypt the document. Before providing access to the decrypted document is provided, reference can be made to the addresses encoded with the encryption key. If the address submitting the access request does not correspond to any of the addresses, then no access is provided. If it does correspond to one of the addresses, access is provided according to the access right. The limitation to accessing the decrypted document can also be provided by the user account, as described above with respect to FIG. 2B.

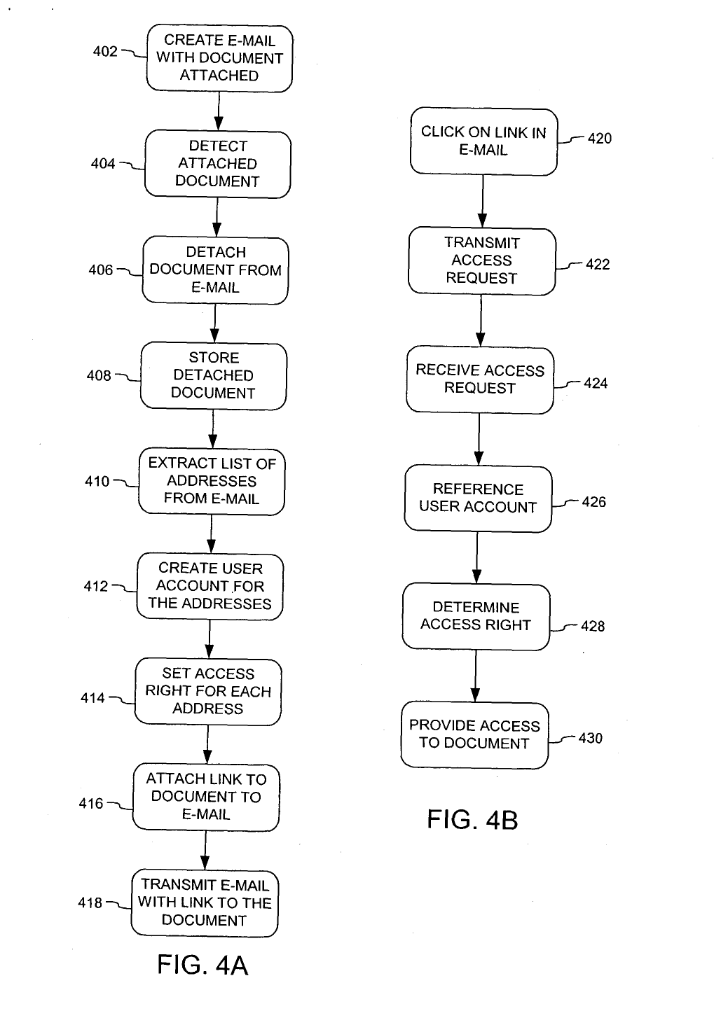

In addition to creating an e-mail message with a link to a document, a user can create an e-mail message with the document attached. FIGS. 4A and 4B are flow diagrams of another process for providing access to a shared document according to an embodiment of the present invention in the situation where the document itself is attached to the e-mail message. As shown in FIG. 4A, a user first creates an e-mail message with a document attached to the e-mail message (step 402). For example, a user at the sender workstation 10 can create the e-mail message using the e-mail server 20 with a link to a document stored in the file server 40. The link can be a local address corresponding to the location where the document is stored in the storage area of the file server 40 or a universal address, such as a URL or HTTP address. The user also identifies each recipient addresses. The addresses can be e-mail addresses of the sender workstations 60.

Before the e-mail is transmitted to the addresses identified in the e-mail message, the system detects whether there is a document attached to the e-mail message (step 304). This detection can be performed by the e-mail server 20 or whatever e-mail application the user used to create the e-mail message. In addition to being configured to create, send, receive and store e-mail messages, the e-mail server 20 can be configured to analyze an e-mail message prior to being transmitted to determine whether the e-mail message includes an attached document.

If an attached document is detected, the document is detached from the e-mail message (step 406). The detachment of the document, which removes a copy of the document from the e-mail message, can be performed by the e-mail server 20 or the e-mail application used to create the e-mail message. The detached document is then stored in a storage area (step 408). The storage area can be the file server 40 or other storage location accessible to the sender workstation 10.

In addition to detaching and storing the document, the system extracts identified recipient addresses in the e-mail message (step 410), the extracted addresses are used to create a user account (step 412), and an access right to the detached document is set for each address extracted from the e-mail message (step 414). The user account and access right can be created and stored as described above with respect to FIG. 2A.

Instead of including the attached document in the e-mail message, a link to the detached document is attached to the e-mail message (step 416). The link corresponds to the location at which the detached document is stored. After attaching the link, the e-mail message with the link to the document is sent to each of the addresses in the message (step 418). The e-mail server 20 or e-mail application used to create the e-mail message can be configured to control the transmission of the e-mail message, such as from the sender workstation 10 to one or more of the receiver workstations 60.

The users at each of the addresses receiving the e-mail message can use the link to the document in the e-mail message to access the document in the same manner as described above with respect to FIG. 2B. As shown in FIG. 4B, the user can access the document by first clicking on the link in the e-mail message, such as by using a mouse (step 420).

In response to clicking on the link to the document in the e-mail message, an access request is transmitted to the location of the document (step 422). The access request includes information identifying the location of the document, such as its HTTP address, and information identifying the user sending the access request, such as by the user's e-mail address. The information identifying the location of the document can be used to direct the transmission of the access request. The access request is received at the location of the document (step 424). For example, if the e-mail message links to a document in the file server 20, then the access request is transmitted to the file server 20.

Before enabling access to the document, the user account corresponding to the document is referenced (step 426). As described above, the user account may be stored in the user management database 30, which is associated with the file server 20 in which the linked document is stored. The user account is referenced to determine whether or not the user that transmitted the access request is entitled to access the document. For example, the user that transmitted the access request is entitled to access the document if the information identifying the user, such as the user's e-mail address, is denoted in the user account. If the information identifying the user is not denoted in the user account, then the user is not entitled to access the document. This may occur if the original recipient of the e-mail forwards the link to the document to another address that was not among the original addresses included in the e-mail message.

If the user transmitting the access request is entitled to access the document, the system determines the user's access right to the document (step 428). As described above, the user account associated with the document identifies the access right for each address to which the link to the document is transmitted. Using the address identifying the user transmitting the access request and the user account information, the system can determine what access right the user has to the linked document.

Based on the determined access right, the user is provided access to the document (step 430). For example, if the determined access right is read-only, then the user is only able to view the document, but not change its contents. However, if the determined access right is read-write access, then the user is allowed to view the document, as well as change its contents.

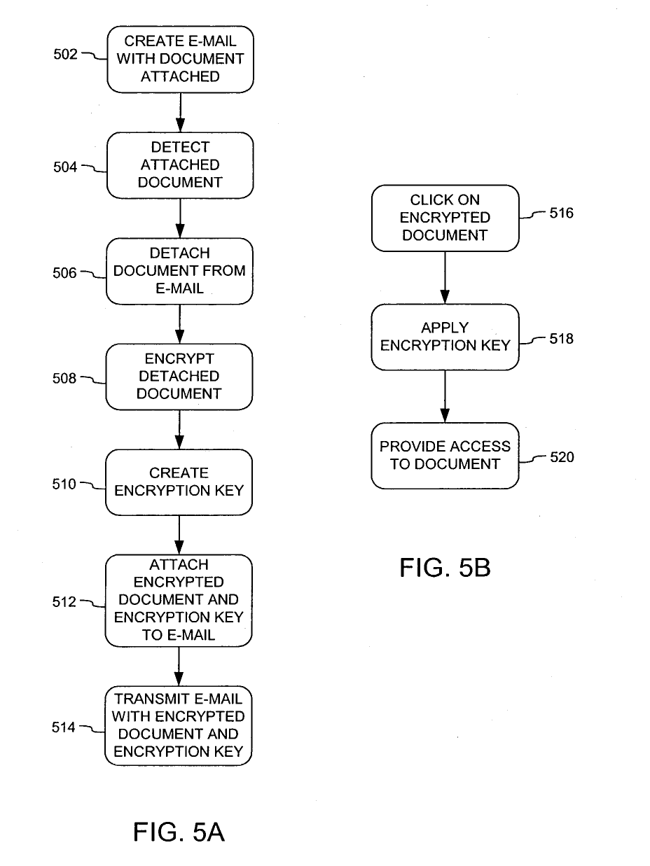

In the process of FIG. 4A, a document attached to an e-mail is detached from the e-mail and replaced with a link to the document. In addition, a user account is created to limit access to the linked document to the addresses identified in the e-mail message. Limiting the access to the document can also be achieved by encrypting the attached document. FIGS. 5A and 5B are flow diagrams of another process for providing access to a shared document according to an embodiment of the present invention by encrypting the attached document. As shown in FIG. 5A, a user first creates an e-mail message with a document attached to the e-mail message (step 502). The e-mail message can be created in the same manner as described above. Before the e-mail is transmitted to the addresses identified in the e-mail message, the system detects whether the existence of an attached document (step 504). If an attached document is detected, the document is detached from the e-mail message (step 506).

Instead of storing the document, creating a user account and attaching a link to the document as described above in FIG. 4A, the detached document is encrypted (step 508). As previously noted, a variety of encryption algorithms exist that may be used to encrypt the document as is known to those skilled in the art, and this process may be used with any such encryption algorithm. Encryption algorithms include, for example, PDP algorithms. In addition to encrypting the document, an encryption key is created (step 510). As described above, the encryption key depends on the type of encryption algorithm used to encrypt the document. The encryption key can be encoded with information about the recipient addresses. The encoding of this address information can limit the use of the encryption key to users associated with those addresses. The encoding of the encryption key can also include information identifying the access right for those addresses. The access right can be a default setting, or specified by the user as prompted.

The encrypted document is then attached to the e-mail message along with the encryption key (step 512). The attaching of the encrypted document and encryption key can be performed by the e-mail server 20 or the e-mail application used to generate the e-mail message. After attaching the encrypted document and encryption key, the e-mail message is transmitted to each of the addresses identified in the e-mail message (step 514). The e-mail server 20 or e-mail application used to create the e-mail message can be configured to control the transmission of the e-mail message, such as from the sender workstation 10 to one or more of the receiver workstations 60.

In response to receiving the e-mail message, a user associated with an address in the e-mail message can access the attached encrypted document. As shown in FIG. 5B, the user clicks on the encrypted document attached to the e-mail message (step 516). To initiate the access to the encrypted document, the user typically will double-click on the document. If clicking on the document does not initiate the access, it may be necessary to save the document to a storage area, along with the encryption key and access the document from the storage area.

After initiating the access to the encrypted document, the encryption key is applied (step 518). The manner in which the document is decrypted depends on the algorithm used to encrypt the document. Before providing access to the decrypted document, reference can be made to the addresses encoded with the encryption key. If the address at which the user attempts to access the encrypted document does not correspond to any of the addresses in the e-mail message, then no access is provided. If it does correspond to one of the addresses, then the document is decrypted. The user is then provided with access to the decrypted document (step 520). If the encryption key is encoded with information about the access right to the document, then the system provides access in accordance with the access right.

In the process of FIGS. 5A and 5B, the encrypted document is attached to the e-mail and provided to each recipient address. It is also possible to replace the encrypted document with the link to the encrypted document. If the link is sent instead of the encrypted document, then the access request to the encrypted document would include the encryption key. The encryption key can still have the address and access right information encoded within it to limit the access to the encryption document. Alternatively, at the time the document is encrypted, the system can create a user account from the addresses in the e-mail message to control access to the encrypted document.

In any of the foregoing embodiments, the recipient addresses in a particular application may include alternative e-mail addresses of that recipient based on remote access or through the system learning alternative e-mail addresses. In addition, it is possible to extinguish the access rights for a recipient address in response to an action of the user at the recipient address. For example, if a user forwards a linked or attached document to another user, the e-mail server 20 can recognize this action and alter the user account to extinguish the access rights for that user.

The foregoing description of preferred embodiments of the invention has been presented for purposes of illustration and description. It is not intended to be exhaustive or to limit the invention to the precise form disclosed, and modifications and variations are possible in light in the above teachings or may be acquired from practice of the invention. Any aspect of each embodiment can be combined with another aspect of another embodiment The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

1. A method for controlling transmission of an e-mail message, comprising:
determining whether an e-mail message being transmitted to one or more addresses includes a link to a document;
detecting each of the one or more addresses to which the e-mail message is being transmitted;
creating at least one user account for the detected one or more addresses;
setting an access right to the linked document for each of the one or more addresses in the at least one user account; and
transmitting the e-mail message with the document link to each of the one or more addresses.

2. The method according to claim 1, further comprising receiving a request to access the document linked in the transmitted e-mail message, the request including the address of the user requesting the access.

3. The method according to claim 2, further comprising:
referencing the address included in the access request to the one or more addresses in the at least one user account; and
providing the user access to the document if the address included in the access request is an address in the at least one user account.

4. The method according to claim 3, further comprising:
determining the access right associated with the user requesting access; and
providing access to the document according to the access right.

5. The method according to claim 1, wherein the access right set for a first address is different than the access right set for a second address.

6. The method according to claim 1,
detecting that the document link was forwarded to another address from one of the one or more addresses; and
extinguishing the access right to the linked document for the one address forwarding the document link.

7. A method for controlling transmission of an e-mail message, comprising:
determining whether an e-mail message being transmitted to one or more addresses includes a link to a document;
detecting whether the linked document is encrypted;
retrieving an encryption key for decrypting the encrypted linked document;
attaching the encryption key to the e-mail message; and
transmitting the e-mail message with the document link and the encryption key to each of the one or more addresses.

8. The method according to claim 7, further comprising receiving a request to access the document linked in the transmitted e-mail message, the request including the address of the user requesting the access and the encryption key.

9. The method according to claim 8, further comprising:
locating the encrypted document in response to the reception of the access request; and
decrypting the encrypted document with the encryption key.

10. The method according to claim 7, further comprising:
detecting each of the one or more addresses to which the e-mail message is being transmitted;
creating at least one user account for the detected one or more addresses; and
setting an access right to the linked document for each of the one or more addresses in the at least one user account.

11. The method according to claim 10, further comprising:
receiving a request to access the document linked in the transmitted e-mail message, the request including the address of the user requesting the access;
referencing the address included in the access request to the one or more addresses in the at least one user account; and
providing the user access to the document if the address included in the access request is an address in the at least one user account.

12. The method according to claim 7, further comprising:
embedding the encryption key with an access right to the linked document for each of the one or more addresses;
receiving a request to access the document linked in the transmitted e-mail message, the request including the address of the user requesting the access and the encryption key;
referencing the address included in the access request to the one or more addresses embedded in the encryption key; and
providing the user access to the document if the address included in the access request is an address embedded in the encryption key.

13. A method for controlling transmission of an e-mail message, comprising:
determining whether an e-mail message being transmitted to one or more addresses includes an attached document;
detaching the attached document from the e-mail message when a document is attached;
storing the attached document in a storage area;
detecting each of the one or more addresses to which the e-mail message is being transmitted;
creating at least one user account for the detected one or more addresses;
setting an access right to the document for each of the one or more addresses in the at least one user account;
attaching a link to the document to the e-mail message; and
transmitting the e-mail message with the document link to each of the one or more addresses.

14. The method according to claim 13, further comprising receiving a request to access the document linked in the transmitted e-mail message, the request including the address of the user requesting the access.

15. The method according to claim 14, further comprising:
referencing the address included in the access request to the one or more addresses in the at least one user account; and
providing the user access to the document if the address included in the access request is an address in the at least one user account.

16. The method according to claim 15, further comprising:
determining the access right associated with the user requesting access; and
providing access to the document according to the access right.

17. A method for controlling transmission an e-mail message, comprising:
determining whether an e-mail message being transmitted to one or more addresses includes an attached document;
detaching the attached document from the e-mail message when a document is attached;
encrypting the detached document into an encrypted document;
creating an encryption key for decrypting the encrypted document;
attaching the encrypted document and the encryption key to the e-mail message; and
transmitting the e-mail message with the encrypted document and the encryption key to each of the one or more addresses.

18. The method according to claim 17, further comprising receiving a request to access the document linked in the transmitted e-mail message, the request including the address of the user requesting the access and the encryption key.

19. The method according to claim 18, further comprising:
locating the encrypted document in response to the reception of the access request; and
decrypting the encrypted document with the encryption key.

20. The method according to claim 17, further comprising:
embedding the encryption key with an access right to the linked document for each of the one or more addresses;
receiving a request to access the document linked in the transmitted e-mail message, the request including the address of the user requesting the access and the encryption key;
referencing the address included in the access request to the one or more addresses embedded in the encryption key; and
providing the user access to the document if the address included in the access request is an address embedded in the encryption key.

21. A system for controlling transmission of an e-mail message, comprising:
a processor; and
a memory, coupled to the processor, the memory comprising a plurality of instructions executed by the processor configured to:
determine whether an e-mail message being transmitted to one or more addresses includes a link to a document;
detect each of the one or more addresses to which the e-mail message is being transmitted;
create at least one user account for the detected one or more addresses;
set an access right to the linked document for each of the one or more addresses in the at least one user account; and
transmit the e-mail message with the document link to each of the one or more addresses.

22. The system according to claim 21, the memory further comprising an instruction configured to receive a request to access the document linked in the transmitted e-mail message, the request including the address of the user requesting the access.

23. The system according to claim 22, the memory further comprising instructions configured to:
reference the address included in the access request to the one or more addresses in the at least one user account; and
provide the user access to the document if the address included in the access request is an address in the at least one user account.

24. The system according to claim 23, the memory further comprising instructions configured to:
determine the access right associated with the user requesting access; and
provide access to the document according to the access right.

25. The system according to claim 21, the memory further comprising instructions configured to:
detect that the document link was forwarded to another address from one of the one or more addresses; and
extinguish the access right to the linked document for the one address forwarding the document link.

26. The system according to claim 21, wherein the access right set for a first address is different than the access right set for a second address.

27. A system for controlling transmission of an e-mail message, comprising:
a processor,
a memory, coupled to the processor, comprising a plurality of instructions executed by the processor configured to:
determine whether an e-mail message being transmitted to one or more addresses includes a link to a document;
detect whether the linked document is encrypted;
retrieve an encryption key for decrypting the encrypted linked document;
attach the encryption key to the e-mail message; and
transmit the e-mail message with the document link and the encryption key to each of the one or more addresses.

28. The system according to claim 27, the memory further comprising an instruction configured to receive a request to access the document linked in the transmitted e-mail message, the request including the address of the user requesting the access and the encryption key.

29. The system according to claim 28, the memory further comprising instructions configured to:
locate the encrypted document in response to the reception of the access request; and
decrypt the encrypted document with the encryption key.

30. The system according to claim 27, the memory further comprising instructions configured to:
detect each of the one or more addresses to which the e-mail message is being transmitted;
create at least one user account for the detected one or more addresses; and
set an access right to the linked document for each of the one or more addresses in the at least one user account.

31. The system according to claim 30, the memory further comprising instructions configured to:
receive a request to access the document linked in the transmitted e-mail message, the request including the address of the user requesting the access;
reference the address included in the access request to the one or more addresses in the at least one user account; and
provide the user access to the document if the address included in the access request is an address in the at least one user account.

32. The system according to claim 27, the memory further comprising instructions configured to:
embed the encryption key with an access right to the linked document for each of the one or more addresses;
receive a request to access the document linked in the transmitted e-mail message, the request including the address of the user requesting the access and the encryption key;
reference the address included in the access request to the one or more addresses embedded in the encryption key; and
provide the user access to the document if the address included in the access request is an address embedded in the encryption key.

33. A system for controlling transmission of an e-mail message, comprising:
a processor,
a memory, coupled to the processor, comprising a plurality of instructions executed by the processor configured to:
determine whether an e-mail message being transmitted to one or more addresses includes an attached document;
detach the attached document from the e-mail message when a document is attached;
store the attached document in a storage area;
detect each of the one or more addresses to which the e-mail message is being transmitted;
create at least one user account for the detected one or more addresses;
set an access right to the document for each of the one or more addresses in the at least one user account;
attach a link to the document to the e-mail message; and
transmit the e-mail message with the document link to each of the one or more addresses.

34. The system according to claim 33, the memory further comprising an instruction configured to receive a request to access the document linked in the transmitted e-mail message, the request including the address of the user requesting the access.

35. The system according to claim 34, the memory further comprising instructions configured to:
reference the address included in the access request to the one or more addresses in the at least one user account; and
provide the user access to the document if the address included in the access request is an address in the at least one user account.

36. The system according to claim 35, the memory further comprising instructions configured to:
determine the access right associated with the user requesting access; and
provide access to the document according to the access right.

37. A system for controlling transmission an e-mail message, comprising:
a processor;
a memory, coupled to the processor, comprising a plurality of instructions executed by the processor configured to:
determine whether an e-mail message being transmitted to one or more addresses includes an attached document;
detach the attached document from the e-mail message when a document is attached;
encrypt the detached document into an encrypted document;
create an encryption key for decrypting the encrypted document;
attach the encrypted document and the encryption key to the e-mail message; and
transmit the e-mail message with the encrypted document and the encryption key to each of the one or more addresses.

38. The system according to claim 37, the memory further comprising an instruction configured to receive a request to access the document linked in the transmitted e-mail message, the request including the address of the user requesting the access and the encryption key.

39. The system according to claim 38, the memory further comprising instructions configured to:
locate the encrypted document in response to the reception of the access request; and
decrypt the encrypted document with the encryption key.

40. The system according to claim 37, the memory further comprising instructions configured to:
embed the encryption key with an access right to the linked document for each of the one or more addresses
receive a request to access the document linked in the transmitted e-mail message, the request including the address of the user requesting the access and the encryption key;
reference the address included in the access request to the one or more addresses embedded in the encryption key; and
provide the user access to the document if the address included in the access request is an address embedded in the encryption key.
